(19) United States
(12) Patent Application Publication
(10) Pub. No.: US 2026/0041096 A1
(43) Pub. Date: Feb. 12, 2026

(54) USE OF NAPHTHALENE SULPHONATE AS COMPATIBILIZER IN TANK MIX COMPOSITION

(71) Applicant: SPECIALTY OPERATIONS FRANCE, Lyon (FR)

(72) Inventors: Ritu Ahuja, Singapore (SG); Sandeep Thakur, Gujarat (IN); Aditi Desai, Gujarat (IN); Fernanda De Oliveira Barreto Costa, Paulinia (BR)

(73) Assignee: SPECIALTY OPERATIONS FRANCE, Lyon (FR)

(21) Appl. No.: 19/102,356

(22) PCT Filed: Aug. 9, 2022
(86) PCT No.: PCT/EP2022/072336

§ 371 Date: Feb. 7, 2025

(51) Int. Cl. A01N 47/26; A01N 25/04; A01N 25/22; A01P 3/00

(52) U.S. Cl. CPC A01N 47/26; A01N 25/04; A01N 25/22; A01P 3/00

(57) ABSTRACT

The present invention relates to a pesticide formulation comprising an in-build naphthalene sulphonate or the formaldehyde condensates thereof as compatibilizer. In addition, the present invention further comprises a tank mix composition prepared from the pesticide formulation.

### FIELD OF THE INVENTION

The present invention relates to a pesticide formulation comprising an in-build naphthalene sulphonate or the formaldehyde condensates thereof as compatibilizer. In addition, the present invention further relates to a tank mix composition prepared from the pesticide formulation.

### BACKGROUND

Mancozeb is a dithiocarbamate fungicide. It is the zinc ion coordination product with manganese ethylene-1,2-bisdithiocarbamate polymer, having the following chemical structure:

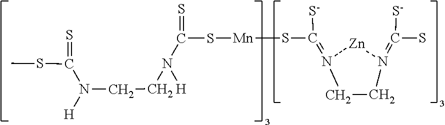

Mancozeb has a polymeric structure containing 1.6 percent zinc, in which the standard composition of Mancozeb available in the art is an 80 percent wettable powder containing 16% manganese and 2% zinc.

Farmers usually practice tank mixing different pesticide formulations for enhanced efficiency and convenience as it reduces the number of sprays time, labor cost etc. Secondly, it decrease the likelihood of pesticide resistance by applying products with multiple modes of action together. In order to further increase the efficiency adjuvants like spreader, stickers, drift reducing agents, penetrating agents are used of the formulations.

In case of Mancozeb, being a contact fungicide is generally mixed with other pesticide formulation and adjuvants before spraying on the plant in order to have the above advantages. This leads to physical incompatibility in the tank-mix leading to curdling, sedimentation, flocculation, etc. Therefore compatibilizer is typically used to reduce such incompatibility. Mostly tank-mix compatibilizers are added directly into the tank-mix. It is observed that proper sequence/steps of addition has to be followed by the farmer before tank mixing different ingredients. If missed, it will result in unstable tank-mix with compatibility issues etc. Therefore, it is preferred to avoid number of steps formulations with built-in compatibilizers. However, it may have a negative impact on the physiochemical property of the formulation, i.e suspensibility, appearance, long term stability, flowability etc, if incorporating compatibilizer as a built-in which may avoid such inconvenience. Expertise and extensive work are required to solve such technical disadvantages.

Thus it is still desirable to provide a pesticide formulation with built-in compatibilizer.

### SUMMARY OF THE INVENTION

In one aspect of the present invention, it is provided a pesticide composition, comprising:
a) an agricultural active selected from dithiocarbamate fungicide, wherein the agricultural active presents in an amount ranging from 1 to 85 wt. %, preferably from 20 to 80 wt. % and particularly preferably from 30 to 80 wt. %, based on the total weight of the pesticide composition;
b) a compatibilizer selected from naphthalene sulphonate or the formaldehyde condensates thereof, wherein the naphthalene sulphonate is represented by the formula I and present in an amount of ranging from 0.1 to 70 wt. %, preferably from 0.5 to 30 wt. % and particularly preferably from 0.5 to 20 wt. %, based on the total weight of the pesticide composition;

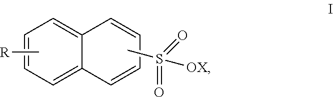

wherein R represents one or more substituents selected from C₁ to C₆ alkyl, X represents a cation selected from ammonium, alkyl or alkanol ammonium; and
c) optional a carrier, wherein the inert presents in an amount ranging from 0.1 to 99 wt. %, preferably from 0.5 to 90 wt. %, and particularly preferably from 1 to 90 wt. %, based on the total weight of the pesticide composition.

The pesticide composition of the present invention build-in a compatibilizer therein, not only meet the marketing needs, but also has favorable suspensibility, wettability and compatibility.

In one embodiment of the present invention, the dithiocarbamate fungicide is selected from Ziram, Thiram, Metiram, Maneb, Propineb, Zineb, Mancozeb and the combination thereof.

In another embodiment of the present invention, the pesticide composition further comprises an adjuvant selected from sodium or calcium salt of naphthalene sulphonate as defined by the formula I or the formaldehyde condensates thereof, wherein X represents sodium or calcium.

In still another embodiment of the present invention, the pesticide composition is formulated as a Wettable Powder (WP), Suspension Concentrate (SC), Suspoemulsion (SE), Emulsion in water (EW), Dispersible concentrate (DC), Water dispersible Granules (WDG or WG), or Soluble granules (SG or WSG).

In another aspect of the present invention, it is provided an agricultural tank-mix composition comprising:
i) the pesticide composition as previously described;
ii) an agricultural active selected from Azoxystrobin, Tebuconazole, picoxystrobin, pyraclostrobin, trifloxystrobin, dimoxystrobin, metominostrobin, orysastrobin, fluoxastrobin, captan, carbendazim, chlorothalonil, copper and its derivatives, copper sulphate, difenoconazole, epoxicnazole, hexaconazole, iprodione, kresoxim-methyl, metalaxyl, metiram, propiconazole, propineb, sulphur, tebuconazole, thifluzamide, thiophanate-methyl, thiram, trifloxystrobin, zineb, ziram, Propineb, Maneb, abamectin, acetamiprid, amitraz, azadirachtin, bifenthrin, buprofezin, lambda-cyhalothrin, difenthiuron, emamectin benzoate, fenpyroximate, fipronil, imidacloprid, lufenuron, nitenpyram, novaluron, pymetrozin, spinosad, teflubenzuron, thiamethoxam, and salts and mixtures thereof;
iii) a liquid medium wholly or partly formed from mineral oils, paraffin oils, plant oils or alkyl esters thereof, fatty acid alkyl esters and mixtures thereof.

In still another aspect of the present invention, it is provided the use of naphthalene sulphonate or the formaldehyde condensates thereof as a compatibilizer for a pesticide composition comprising an agricultural active selected from dithiocarbamate fungicide, wherein the agricultural active presents in an amount ranging from 1 to 85 wt. %, preferably from 20 to 80 wt. % and particularly preferably from 30 to 80 wt. %, based on the total weight of the pesticide composition; wherein the naphthalene sulphonate is represented by the formula I and present in an amount of ranging from 0.1 to 70 wt. %, preferably from 0.5 to 30 wt. % and particularly preferably from 0.5 to 20 wt. %, based on the total weight of the pesticide composition

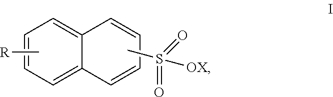

wherein R represents one or more substituents selected from C₁ to C₆ alkyl, X represents a cation selected from ammonium, alkyl or alkanol ammonium.

### DETAILED DESCRIPTION OF THE INVENTION

Throughout the description, including the claims, the term “comprising one” or “comprising a” should be understood as being synonymous with the term “comprising at least one”, unless otherwise specified. The terms “between” and “from . . . to . . . ” should be understood as being inclusive of the limits.

The articles “a”, “an” and “the” are used to refer to one or to more than one (i.e., to at least one) of the grammatical object of the article.

It should be noted that in specifying any range of concentration, weight ratio or amount, any particular upper concentration, weight ratio or amount can be associated with any particular lower concentration, weight ratio or amount, respectively.

As used herein, the term “alkyl” means a saturated hydrocarbon radical, which may be straight, branched or cyclic, such as, methyl, ethyl, n-propyl, iso-propyl, n-butyl, sec-butyl, t-butyl, pentyl, n-hexyl, cyclohexyl.

As used herein, the terminology “(Cn-Cm)” in reference to an organic group, wherein n and m are each integers, indicates that the group may contain from n carbon atoms to m carbon atoms per group.

### Pesticide Composition

In one aspect of the present invention, it is provided a pesticide composition, comprising:
a) an agricultural active selected from dithiocarbamate fungicide, wherein the agricultural active presents in an amount ranging from 1 to 85 wt. %, preferably from 20 to 80 wt. % and particularly preferably from 30 to 80 wt. %, based on the total weight of the pesticide composition;
b) a compatibilizer selected from naphthalene sulphonate or formaldehyde condensates thereof, wherein the naphthalene sulphonate is represented by the formula I and present in an amount of ranging from 0.1 to 70 wt. %, preferably from 0.5 to 30 wt. % and particularly preferably from 0.5 to 20 wt. %, based on the total weight of the pesticide composition;

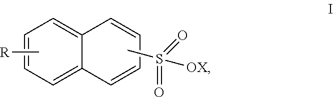

wherein R represents one or more substituents selected from C₁ to C₆ alkyl, X represents a cation selected from ammonium, alkyl or alkanol ammonium; and
c) optional an inert, wherein the inert presents in an amount ranging from 0.1 to 99 wt. %, preferably from 0.5 to 90 wt. %, and particularly preferably from 1 to 90 wt. %, based on the total weight of the pesticide composition.

The agricultural active (also known as Al) contemplated in the present invention is selected from dithiocarbamate fungicide. Dithiocarbamate fungicides are a group of fungicides widely used since the 1940s to control several hundred fungal pathogens in a variety of crops. Their molecules contain a metal atom that determines their name. Thus, there are, for example, Maneb (Mn), Ziram and Zineb (Zn), and Mancozeb (Mn and Zn). Thiram is an example of dithiocarbamates without a metal moiety.

In one embodiment of the present invention, the dithiocarbamate fungicide is selected from Ziram, Thiram, Metiram, Maneb, Propineb, Zineb, Mancozeb and the combination thereof.

In another embodiment of the present invention, the dithiocarbamate fungicide is selected from Mancozeb.

The agricultural active presents in an amount ranging from 1 to 85 wt. %, preferably from 20 to 80 wt. % and particularly preferably from 30 to 80 wt. %, based on the total weight of the pesticide composition

In the present invention, the compatibilizer contemplated in the present invention is selected from naphthalene sulphonate or the formaldehyde condensates thereof, wherein the naphthalene sulphonate is represented by the formula I,

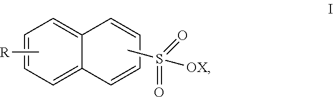

wherein R represents one or more substituents selected from H or C₁ to C₆ alkyl, X represents a cation selected from selected from ammonium, alkyl or alkanol ammonium.

In one embodiment of the present invention, R is selected from methyl, ethyl, propyl, and butyl, preferably selected from methyl.

In one embodiment of the present invention, X represents ammonium.

In one embodiment of the present invention, the compatibilizer is selected from naphthalene sulphonate formaldehyde condensate which can be represented by formula II:

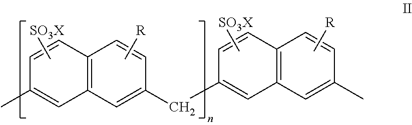

Wherein, R and X are defined as above, n is an integer ranging from 1 to 5.

In the present invention, the compatibilizer contemplated in the present invention present in an amount of ranging from 0.1 to 70 wt. %, preferably from 0.5 to 30 wt. % and particularly preferably from 0.5 to 20 wt. %, based on the total weight of the pesticide composition.

In one embodiment of the present invention, the pesticide composition is formulated as a Wettable Powder (WP), Suspension Concentrate (SC), Suspoemulsion (SE), Emulsion in water (EW), Dispersible concentrate (DC), Water dispersible Granules (WDG or WG), or Soluble granules (SG or WSG).

In another embodiment of the present invention, the pesticide composition is formulated as a wettable powder, which may be compacted to form water-dispersible granules, comprising an intimate mixture of the agricultural active, a carrier and the compatibilizer.

In the preparation of wettable powder formulations, the dithiocarbamate fungicide can be compounded with suitable carries. The carriers can be contemplated in the present invention are finely divided solids of various types, such as calcite, talc, kaolin, montmorillonite, attapulgite, highly disperse silicas, highly disperse alluminium oxides, highly disperse absorptive polymers, pumice, brick grit, sepiolite, bentonite, calcite, sand, dolomit, lactose or starch. In such operations, the finely divided carrier is ground or mixed with the dithiocarbamate fungicide in a volatile organic solvent if needed.

In the present invention, the pesticide composition can further comprise addition components, for example organic acids such as citric acid, boric acid, inorganic salts such as ammonium sulphate, salts of alkaline or alkaline earth metals such as calcium sulphate, magnesium sulphate, sodium sulphate, and sodium benzoate.

In one embodiment of the present invention, the pesticide composition can further comprise an adjuvant selected from sodium or calcium salt of naphthalene sulphonate as defined by the formula I or formaldehyde condensates thereof, wherein X represents sodium or calcium.

### Tank-Mix Composition

In another aspect of the present invention, it is provided a tank-mix composition comprising
i) the pesticide composition as illustrated above;
ii) an agricultural active selected from Azoxystrobin, Tebuconazole, picoxystrobin, pyraclostrobin, trifloxystrobin, dimoxystrobin, metominostrobin, orysastrobin, fluoxastrobin, captan, carbendazim, chlorothalonil, copper and its derivatives, copper sulphate, difenoconazole, epoxicnazole, hexaconazole, iprodione, kresoxim-methyl, metalaxyl, metiram, propiconazole, propineb, sulphur, tebuconazole, thifluzamide, thiophanate-methyl, thiram, trifloxystrobin, zineb, ziram, Propineb, Maneb, abamectin, acetamiprid, amitraz, azadirachtin, bifenthrin, buprofezin, lambda-cyhalothrin, difenthiuron, emamectin benzoate, fenpyroximate, fipronil, imidacloprid, lufenuron, nitenpyram, novaluron, pymetrozin, spinosad, teflubenzuron, thiamethoxam salts, and salts and mixtures thereof; and
iii) a liquid medium wholly or partly formed from paraffin oils, plant oils or alkyl esters thereof, fatty acid alkyl esters and mixtures thereof.

The tank-mix composition of the present invention show favorable stability by building in compatibilizer in the pesticide composition.

In addition to the pesticide as illustrated as above, the tank-mix composition of the present invention further comprises a different agricultural actives (ii) for enhanced efficiency and convenience. The different agricultural actives are illustrated as above.

The tank-mix composition of the present invention further comprises a liquid medium. The liquid medium of the tank-mix composition is wholly or partly formed from mineral oils, paraffin oils, plant oils or alkyl esters thereof, fatty acid alkyl esters and mixtures thereof.

For the purpose of the present disclosure, “liquid medium” means a medium that is in the liquid phase at room temperature and atmospheric pressure.

According to a first embodiment, the liquid medium is wholly formed from at least one plant oil or alkyl esters thereof, fatty acid ester or mixtures thereof.

According to a second embodiment, the liquid medium is partly formed from at least one plant oil or alkyl esters thereof, fatty acid alkyl ester or mixtures thereof. The liquid medium thus may comprise other solvents and in particular aromatic solvents such as for example the Solvesso™ solvents commercialized by ExxonMobil Chemical.

Suitable mineral oils are various commercially available distillate fractions of mineral oil (petroleum). Preference is given to mixtures of open-chain C₁₄-C₃₀ hydrocarbons, cyclic hydrocarbons (naphthenes) and aromatic hydrocarbons. The hydrocarbons can be either straight-chain or branched.

Suitable paraffin oils are straight-chain and branched C₁₄-C₃₀ hydrocarbons. Paraffin oils are also known as base oil or white oil and are commercially available, for example, as Bayol® 85 (Exxon Mobil, Machelen, Belgium), Marcol® 82 (Exxon Mobil, Machelen, Belgium).

Suitable plant oils are any single natural, non-petroleum, non-synthetic oil derived from a plant, vegetable or fruit or shrub or flower or tree nut, or any combination of natural, non-petroleum, non-synthetic oils derived from a plant, vegetable or fruit or shrub or tree nut.

The plant oils according to the present disclosure can be selected from soybean oil, rapeseed oil, corn seed oil, sunflower oil, cotton seed oil, linseed oil, coconut oil, palm oil, safflower oil, walnut oil, peanut oil, olive oil or castor oil and mixtures thereof.

As plant oil alkyl esters particularly convenient for the disclosure, the methylated plant oil esters may be cited like for example rapeseed oil methyl ester, soybean oil methyl ester or corn oil methyl ester.

The fatty acid alkyl esters according to the present disclosure can be selected from alkyl esters of C₁₀-C₂₂ alkyl, preferably C₁₂-C₂₀ fatty acids. The C₁₀-C₂₂ fatty acid alkyl esters can be selected from alkyl esters of unsaturated or saturated C₁₀-C₂₂ fatty acids, in particular with an even number of carbon atoms, for example but not limited to, erucic acid, lauric acid, palmitic acid. In one preferable embodiment, fatty acid alkyl esters are selected from C₁₈ fatty acids alkyl ester such as stearic acid, oleic acid, linoleic acid or linolenic acid, in particular oleic acid. Methyl oleate is particular useful in the present invention.

The tank-mix composition of the present invention may comprise liquid medium from 30% to 80% by weight, preferably 35 to 75% by weight of its total weight of the liquid medium.

In another aspect of the present invention, it is provided the use of naphthalene sulphonate or the formaldehyde condensates thereof as a compatibilizer for a pesticide composition comprising an agricultural active selected from dithiocarbamate fungicide,
wherein the agricultural active presents in an amount ranging from 1 to 85 wt. %, preferably from 20 to 80 wt. % and particularly preferably from 30 to 80 wt. %, based on the total weight of the pesticide composition;
wherein the naphthalene sulphonate is represented by the formula I and present in an amount of ranging from 0.1 to 70 wt. %, preferably from 0.5 to 30 wt. % and particularly preferably from 0.5 to 20 wt. %, based on the total weight of the pesticide composition;

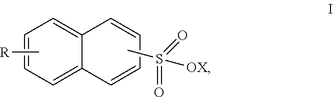

wherein R represents one or more substituents selected from C₁ to C₆ alkyl, X represents a cation selected from ammonium, alkyl or alkanol ammonium.

### EXAMPLES

### Materials

Mancozeb (85%)@75%: Commercially available, wherein 85% refers to the purity of the active and 75% refers to the pesticide loading in the formulation;
CNSA: Condensed Naphthalene Sulfonate Ammonium, ammonium salt of naphthalene formaldehyde condensate sulfonic acid

### 1. The Pesticide Composition

The pesticide composition s were prepared as below:
Weight and blend the ingredients in table 1 in a ribbon blender or domestic mixer;
Subject the ingredients to air-jet milling. Take out the milled ingredients and blend it with previously weighed Mancozeb technical.
Check the physiochemical parameters such as particle size, Suspensibility, wetting etc.

Suspensibility was determined according to the method of CIPAC MT-15, and described as below:
Weigh exact 2.5 grams of the pesticide composition into 250 ml glass beaker containing 100 ml of hard water (342 ppm);
Swirl for 2 mins by hand;
Transfer the solution in the beaker to 250 mml graduated cylinder, rinse the beaker with 25 ml of hard water (342 ppm) and transfer the ingredient to the 250 ml cylinder. Repeat 2-3 times;
Make up the volume of the cylinder to 250 ml with hard water (342 ppm);
Close the cap and of the cylinder and give 30 number of inversions in 1 mins;
Allow the cylinder to stand for 30 mins;
Just after 30 mins are completed suck the top 225 ml of the solution from 250 ml cylinder with the help of a vacuum pump without disturbing the bottom 25 ml solution.;
Transfer the 25 ml solution into a petri dish then dry on a water bath;
Calculate as follows,

$$Suspensibility = \frac{( sample weight in grams - residue weight in grams )}{sample weight in grams} \times 111.11$$

Wettability was determined according to the method of CIPAC MT-53 and described as below:
In a 250 ml glass beaker, containing 100 ml of hard water (342 ppm) add previously weighed 2.5 grams exactly of the pesticide composition;
Start the stopwatch as soon as the previously weighed pesticide composition is added;
Note down the time in seconds it takes for all the pesticide composition sample to wet (indicated as all the material will submerge at the bottom of the beaker).

Sieve test was determined according to method of CIPAC MT-185 and described as below:
In a 250 ml glass beaker, containing 100 ml tap water add previously weighed 10 grams of the pesticide composition. Allow to stand for 1 minute.
Stir with the help of a magnetic stirrer for 5 minutes
Transfer the slurry to a sieve of 200 mesh size and continue rinsing with tap water delivering 4-5 liters of water per minute.
Continue washing till 10 mins maximum slowly.
Transfer the ingredients and weigh the residue left after drying.
Report the amount of material which has been washed out in %.

TABLE 1
the pesticide composition

| | CS1 | CS2 | CS3 | CS4 | CS5 | CS6 |
|---|---|---|---|---|---|---|
| Mancozeb | 88 | 88 | 88 | 88 | 88 | 88 |
| (85%)@75% | | | | | | |
| Condensed | 5 | 12 | | | | |
| methylnaphthalene | | | | | | |
| sulfonate, sodium salt | | | | | | |
| Ammonium salt of | | | 5 | 12 | | |
| Lignosulphonate | | | | | | |
| Calcium salt of | | | | | 5 | 12 |
| Lignosulphonate | | | | | | |
| Silica | 7 | | 7 | | 7 | |
| Total | 100 | 100 | 100 | 100 | 100 | 100 |

0 day results

| Suspensibility | 79.68% | 81.10% | 80.08% | 81.21% | 78.80% | 82.28% |
|---|---|---|---|---|---|---|
| Wettability (sec) | 20 | 22 | 15 | 15 | 20 | 20 |
| pH (tank-mix) | 6.74 | 6.58 | 6.99 | 6.83 | 7.02 | 7.02 |
| Wet sieve (200 Mesh) | >98% | >98% | >98% | >98% | >98% | >98% |

14 days, 54° C.

| Suspensibility | 78.07% | 80.65% | 78.44% | 78.36% | 77.13% | 81.81% |
|---|---|---|---|---|---|---|
| Wettability (sec) | 20 | 20 | 25 | 25 | 20 | 30 |
| pH | 6.65 | 6.48 | 6.83 | 6.82 | 7.1 | 6.8 |
| Wet sieve (200 Mesh) | >98% | >98% | >97% | >97% | >95% | >97% |

| Material | CS7 | CS8 | S1 | S2 |
|---|---|---|---|---|
| Mancozeb @ 75% @85% | 88 | 88 | 88 | 88 |
| Lignosulfonic acid sodium salt | 5 | 12 | | |
| CNSA | | | 5 | 12 |
| Silica | 7 | | 7 | |

0 day results

| Suspensibility | 85.58% | 85.06% | 82.45% | 88.41% |
|---|---|---|---|---|
| Wettability (sec) | 15 | 20 | 25 | 20 |
| pH (tank-mix) | 6.8 | 7.15 | 6.87 | 6.86 |
| Wet sieve (200 Mesh) | >99% | >99% | >99% | >99% |

14 days, 54° C.

| Suspensibility | 78.90% | 83.20% | 81.89% | 86.82% |
|---|---|---|---|---|
| Wettability (sec) | 30 | 30 | 30 | 30 |
| pH | 6.89 | 6.88 | 6.86 | 6.82 |
| Wet sieve (200 Mesh) | >95% | >98% | >99% | >99% |

As shown in table 1, “CS” refers to the comparative examples, “S” refers to the examples of the present invention. In the examples S1 and S2, which build in ammonium salt of naphthalene formaldehyde condensate sulfonic acid in Mancozeb formulation, shows good suspensibility both at 0 day and 14 days 54° C. In addition, the examples of the present invention also show favorable wettability and compatibility over the comparative examples.

### 2. Tank Mix Composition

The tank mix compositions were prepared as follows:
Fill 100 ml graduated crow/tapered cylinder with 80 ml of hard water(342 ppm);
Add the pesticide composition 3 grams;
Now add 0.6 grams of Azoxystrobin 11 and Tebuconazole 18.3% SC;
Add adjuvant in this case 0.25 ml of oil and adjuvants;
Give 10 inversions after every addition;
Make up the volume to 100 ml and give final 10 inversions;
Check the sedimentation after 2 hrs in ml;
After 2 hrs recheck again the number of inversions required for redispersion.

TABLE 2
the tank-mix composition

| | | Azoxystrobin | Sedimentation ml; 2 hrs | |
|---|---|---|---|---|
| | pesticide | 11 + | | Accelerated Heat |
| Tank | composition | Tebuconazole | Ambient | Stability at |
| Mix | (3 grams) | 18.3% SC | (0 day) | 54° C., 14 days |
| TM1 | CS1 | 0.6 grams | 2.5 | 3 |
| TM2 | CS3 | 0.6 grams | 1.6 | 3 |
| TM3 | CS5 | 0.6 grams | 2 | 3 |
| TM4 | CS7 | 0.6 grams | 1.5 | 2 |
| TM5 | S1 | 0.6 grams | 1 | 1.6 |
| TM6 | CS2 | 0.6 grams | 2 | 2.5 |
| TM7 | CS4 | 0.6 grams | 1.1 | 1.6 |
| TM8 | CS6 | 0.6 grams | 1.4 | 2.5 |
| TM9 | CS8 | 0.6 grams | 1.2 | 1.2 |
| TM10 | S2 | 0.6 grams | 0.8 | 1 |

As shown in table 2, the tank-mix compositions of TM5 and TM10 prepared from the pesticide formulation has favorable stability (less sedimentation) over the comparative tank-mix compositions.

1. A pesticide composition, comprising:
a) an agricultural active selected from dithiocarbamate fungicide, wherein the agricultural active is present in an amount ranging from 1 to 85 wt. %, based on a total weight of the pesticide composition;
b) a compatibilizer selected from naphthalene sulphonate or the formaldehyde condensates thereof, wherein the naphthalene sulphonate is represented by the formula I and present in an amount ranging from 0.1 to 70 wt. %, based on the total weight of the pesticide composition; 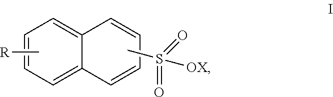
wherein R represents one or more substituents selected from C₁ to C₆ alkyl, X represents a cation selected from ammonium, alkyl or alkanol ammonium; and
c) optionally a carrier, wherein the carrier presents in an amount ranging from 0.1 to 99 wt. %, based on the total weight of the pesticide composition.

2. The pesticide composition according to claim 1, wherein the dithiocarbamate fungicide is selected from Ziram, Thiram, Metiram, Maneb, Propineb, Zineb, Mancozeb and the combination thereof.

3. The pesticide composition according to claim 1, wherein the pesticide composition further comprises an adjuvant selected from sodium or calcium salt of naphthalene sulphonate as defined by the formula I or the formaldehyde condensates thereof, wherein X represents sodium or calcium.

4. The pesticide composition according to claim 1, wherein the pesticide composition is formulated as a Wettable Powder (WP), Suspension Concentrate (SC), Suspoemulsion (SE), Emulsion in water (EW), Dispersible concentrate (DC), Water dispersible Granules (WDG or WG), or Soluble granules (SG or WSG).

5. An agricultural tank-mix composition comprising:
i) the pesticide composition according to claim 1;
ii) an agricultural active selected from Azoxystrobin, Tebuconazole, picoxystrobin, pyraclostrobin, trifloxystrobin, dimoxystrobin, metominostrobin, orysastrobin, fluoxastrobin, captan, carbendazim, chlorothalonil, copper and its derivatives, copper sulphate, difenoconazole, epoxicnazole, hexaconazole, iprodione, kresoxim-methyl, metalaxyl, metiram, propiconazole, propineb, sulphur, tebuconazole, thifluzamide, thiophanate-methyl, thiram, trifloxystrobin, zineb, ziram, Propineb, Maneb, abamectin, acetamiprid, amitraz, azadirachtin, bifenthrin, buprofezin, lambda-cyhalothrin, difenthiuron, emamectin benzoate, fenpyroximate, fipronil, imidacloprid, lufenuron, nitenpyram, novaluron, pymetrozin, spinosad, teflubenzuron, thiamethoxam, and salts and mixtures thereof; and
iii) a liquid medium wholly or partly formed from mineral oils, paraffin oils, plant oils or alkyl esters thereof, fatty acid alkyl esters and mixtures thereof.

6. A method comprising incorporating naphthalene sulphonate or the formaldehyde condensates thereof as a compatibilizer for a pesticide composition comprising an agricultural active selected from dithiocarbamate fungicide, wherein the agricultural active is present in an amount ranging from 1 to 85 wt. %, based on the total weight of the pesticide composition;
wherein the naphthalene sulphonate is represented by the formula I and present in an amount of ranging from 0.1 to 70 wt. %, based on the total weight of the pesticide composition; 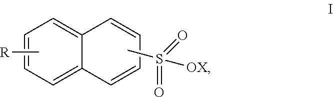
wherein R represents one or more substituents selected from C₁ to C₆ alkyl, X represents a cation selected from ammonium, alkyl or alkanol ammonium.

7. The pesticide composition of claim 1, wherein the compatibilizer is present in an amount ranging from 0.5 to 30 wt. % based on the total weight of the pesticide composition.

8. The pesticide composition of claim 1, wherein the compatibilizer is present in an amount ranging from 0.5 to 20 wt. % based on the total weight of the pesticide composition.
